(19) United States
(12) Patent Application Publication
(10) Pub. No.: US 2016/0028659 A1
(43) Pub. Date: Jan. 28, 2016

(54) System and Method for Targeting Advertisements or Other Information Based on Recently Sent Message or Messages

(71) Applicant: Google Inc., Mountain View, CA (US)

(72) Inventors: Jared Jacobs, Palo Alto, CA (US); Keith Coleman, Palo Alto, CA (US); Niniane Wang, San Francisco, CA (US)

(73) Assignee: Google Inc., Mountain View, CA (US)

(21) Appl. No.: 13/954,811

(22) Filed: Jul. 30, 2013

Related U.S. Application Data
(63) Continuation of application No. 11/215,544, filed on Aug. 29, 2005, now abandoned.

(51) Int. Cl. H04L 12/58

(52) U.S. Cl. CPC H04L 51/00

(57) ABSTRACT

A method of serving information items in association with one or more messages sent by a client includes identifying at least one message sent by a client, obtaining at least one information item associated with the at least one identified message, and preparing for display to the client the at least one information item. The method may include identifying one or more categories associated with the message, or identifying one or more elements in the message that correspond to predefined information entity types. The operation of associating one or more categories with a message may be done before, in parallel, or after sending the messages as an outgoing message.

### RELATED APPLICATIONS

This application is a continuation of U.S. application Ser. No. 11/215,544, filed Aug. 29, 2005, which is incorporated herein by reference in its entirety.

This application is related to U.S. patent application Ser. No. 10/914,035, filed Aug. 6, 2004, entitled “Displaying Conversations in a Conversation-Based Email System,” which is incorporated by reference herein in its entirety. This application is also related to U.S. patent application Ser. No. 11/111,166, filed Apr. 20, 2005, entitled “System and Method for Targeting Information Based on Message Content,” which is incorporated by reference herein in its entirety.

### TECHNICAL FIELD

The disclosed embodiments relate generally to providing information to computer users, and in particular, to provide information to a computer user based on messages recently sent by the computer user.

### BACKGROUND

Online content-targeted advertising typically provides advertisements that are related to the content of an electronic document that a user is viewing, such as a web page or an email message authored by another individual. The present invention, however, is based on a somewhat contrary idea—that a user is likely to be attracted by an advertisement if it is closely related to a document recently authored by the user. In other words, the content of a document recently authored by the user may more accurately reflect the user's current thoughts and interests than a document (e.g., a list of email messages or email conversations) currently being viewed by the user.

### SUMMARY

According to some embodiments, a method of serving information items in association with a message sent by a client includes identifying at least one message sent by a client. At least one information item is obtained in association with the identified message. The information item is prepared and then displayed to the client. In some embodiments, the information item is displayed while the client is viewing a display that does not include the at least one message associated with the information item. In some embodiments, the information item is an advertisement, or a link to an advertisement.

### BRIEF DESCRIPTION OF THE DRAWINGS

For a better understanding of the nature and embodiments of the invention, reference should be made to the Description of Embodiments below, in conjunction with the following drawings in which like reference numerals refer to corresponding parts throughout the figures.

FIG. 1 is a block diagram of an exemplary environment that generates content-targeted information based on message content recently submitted by a client in accordance with some embodiments of the present invention.

FIG. 2 is a flow diagram of a process for generating targeted information based on message content in accordance with some embodiments of the present invention.

FIG. 3 is a flow diagram of a process for identifying a category for message content in accordance with some embodiments of the present invention.

FIG. 4 is a flow diagram of a process for filtering message content in accordance with some embodiments of the present invention.

FIG. 5 is a flow diagram of a process for identifying a pattern in message content and boosting the importance of certain content elements in accordance with some embodiments of the present invention.

FIG. 6 depicts an exemplary data structure for one or more category lists according to some embodiments of the present invention.

FIG. 7 depicts an exemplary data structure for one or more filter lists according to some embodiments of the present invention.

FIGS. 8A and 8B illustrate two exemplary screenshots of a message composition and the display of content-targeted information in accordance with some embodiments of the present invention.

FIG. 9 is a block diagram of an exemplary client in accordance with some embodiments of the present invention.

FIG. 10 is a block diagram of an exemplary information server in accordance with some embodiments of the present invention.

### DESCRIPTION OF EMBODIMENTS

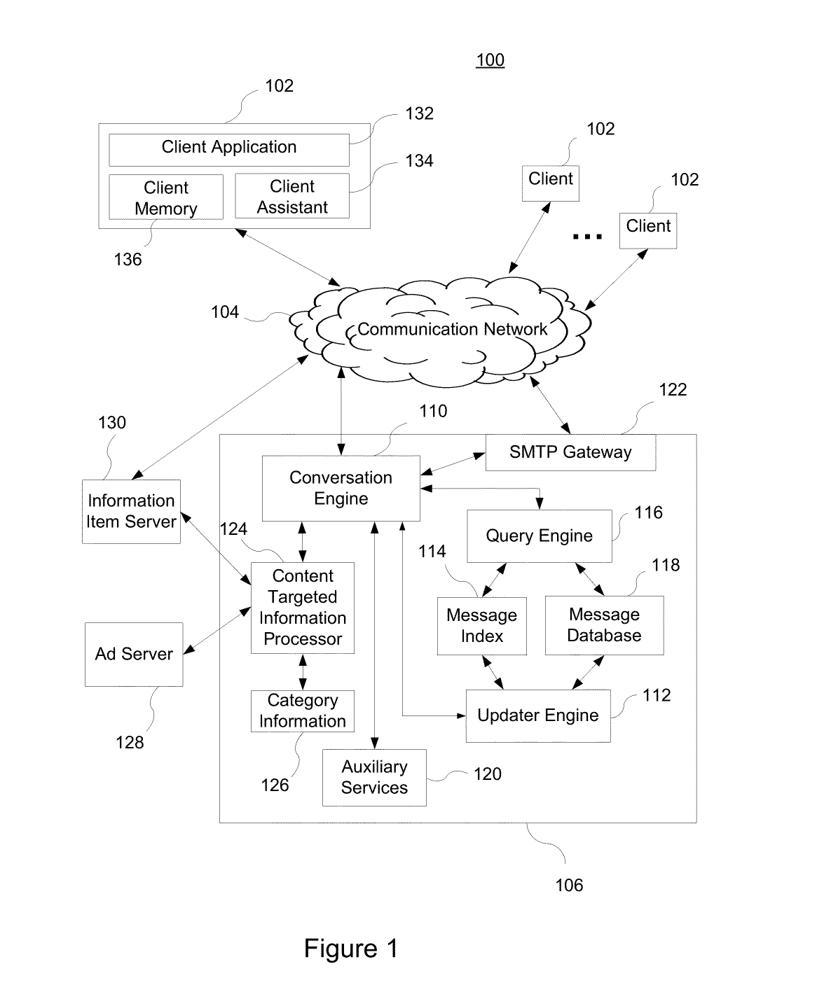

FIG. 1 is a block diagram of a system 100 for implementing some embodiments of the invention. One or more clients 102 can be connected to a communication network 104. The communication network 104 can be connected to an information service 106. The information service 106 can include a conversation engine 110, an updater engine 112, a message index 114, a query engine 116, a message database 118, one or more auxiliary services servers 120, an SMTP gateway 122, a content-targeted information processor 124, and category information 126. The content-targeted information processor 124 can be connected to an ad server 128 and/or one or more information item servers 130.

The client 102 can be any of a number of devices (e.g., a computer, an internet kiosk, a personal digital assistant, a cell phone, a gaming device, a desktop computer, or a laptop computer) and can include a client application 132, a client assistant 134, and/or client memory 136. The client application 132 can be a software application that permits a user to interact with the client 102 and/or network resources to perform one or more tasks. For example, the client application 132 can be a browser (e.g., Firefox) or other type of application that permits a user to search for, browse, and/or use resources (e.g., web pages and web services) on the client 102 and/or accessible via the communication network 104. The client assistant 134 can perform one or more tasks related to monitoring a user's activities with respect to the client application 132 and/or other applications, searching or browsing for resources (e.g., files) on the client 102, and processing information received from or being sent to information service 106. The client assistant 134 can be part of the client application 132, available as a plug-in to the client application 132 (provided, for example, from various on-line sources), or provided as a stand-alone program. The client assistant can be a web-based messaging application such as the client executable portion of the Google Gmail product. A client memory 136 can store system information and information about a user, among other things.

The communication network 104 can be any local area network (LAN) and/or wide area network (WAN), such as an intranet, an extranet, or the Internet. It is sufficient that the communication network 104 provides communication capability between the clients 102 and the information service 106. In some embodiments, the communication network 104 uses the HyperText Transport Protocol (HTTP) to transport information using the Transmission Control Protocol/Internet Protocol (TCP/IP). The HTTP permits client computers to access various resources available via the communication network 104. The various embodiments of the invention, however, are not limited to the use of any particular protocol. The term “resource” as used throughout this specification refers to any piece of information or service that is accessible via a Uniform Resource Locator (URL) and can be, for example, a web page, a document, an email message, an Instant Messaging (IM) message, a Short Message Service (SMS) message, a transcribed voice message, a database, an image, or a computational object.

The conversation engine 110 can respond to a variety of requests from the client assistant 134 related to messages and return conversation-based responses via its connection with the communication network 104. A conversation may include one or more relevant messages relating to a conversation topic. Various criteria can be used to determine which messages are part of each distinct conversation. For example, an analysis can be made of the contents of messages received and/or sent by a user. Messages whose contents are found to be related can be grouped together. In another example, a thread identifier found in a message header can also be used to identify related messages. In a further example, a subject line in the message header can be used to identify related messages. The senders and recipients of the messages are participants in the conversation. All messages directed to a user of the information service 106 can be grouped into a plurality of conversations and presented to the user in a conversation-based format, individually or jointly. In a conversation list view, a user can see in a summary form a list of conversations in which the user participates. In a conversation view, the user can see in an expanded form one or more of messages associated with a particular conversation.

The information service 106 can create a snippet of a conversation or a message. A snippet provides a user with a preview of the contents of the conversation or message without the user having to open the conversation or the message. In a list of conversations, the snippet can be generated from the most recent message in the conversation. The snippet can also be extracted from the first message (i.e., the oldest message) in the conversation. The snippet can also be extracted from all the messages in the conversation according to predefined heuristic rules, e.g., listing a set of keywords appearing most frequently in the conversation. If the information service 106 is preparing a list of conversations in response to a search submitted by a user, the information service 106 can create a snippet for each conversation in the list, or for each conversation is a displayed portion of the list, the snippet including a portion of the conversation that matches user-submitted query terms. These snippets may be similar in one or more respects to snippets included in search results returned by a search engine, such as the Google search engine. In a conversation view, a snippet can be generated for one or more messages in the conversation.

The SMTP gateway 122 is also connected to the communication network 104. The SMTP gateway 122 can be directly involved in receiving and sending messages between the information service 106 and other email systems, messaging systems or information services. In some embodiments, the SMTP gateway 122, for example, transmits and receives messages using the simple mail transfer protocol (SMTP). The SMTP gateway 122 can receive a new message from the communication network 104 and send the message to conversation engine 110 for additional processing. Additionally, the SMTP gateway 122 can receive messages from the conversation engine 110 and then transmit (via the communication network 104) those messages to recipient addresses specified in the messages.

The one or more auxiliary services servers 120 can provide additional services to the conversation engine 110. The auxiliary services servers 120 can, for example, include a spam detection module for detecting and processing spam and/or an attachment management module for managing the storage and retrieval of documents attached to messages.

As mentioned above, the conversation engine 110 can be connected to the content-targeted information processor 124. The content-targeted information processor 124 can provide content-targeted information for display to a user at client 102. The content-targeted information processor 124 can provide, for example, advertisements and/or other information items related to the user's messages being handled by the conversation engine 110. In some embodiments, the messages include not only messages received by the user but also messages authored and sent by the user. Advertisements are herein defined to mean information items, or links to information items, that offer or promote products, services, events, companies, organizations, ideas or the like.

The content-targeted information processor 124 can be connected to category information 126 which is used by the content-targeted information processor 124 to identify various categories as described below. The category information can be used to obtain, for example, category-related advertisements and/or other supplemental information. Category-related advertisements can be obtained, for example, from ad server 128. Category-related other information can be obtained, for example, from information item server 130.

FIG. 1 is exemplary. In some embodiments, the information service 106 contains a subset or superset of those elements illustrated in the figure. Although FIG. 1 shows the information service 106 as a number of discrete elements, this figure is intended more as a functional description of the various features which may be present in the information service 106 than as a structural schematic of the various embodiments. In practice, and as recognized by those of ordinary skill in the art, some elements shown separately could be combined and some elements could be further divided into sub-elements or parallel elements. For example, some separate elements in the figure could be implemented by a single server or module and some single elements could be implemented by one or more servers or modules. The actual number of servers in information service 106 and how features are allocated among the servers will vary from one implementation to another, and may depend in part on the amount of traffic that the system must handle during peak usage periods as well as during average usage periods. For example, the message database 118 can be implemented using a plurality of servers if the information service 106 manages a large volume of messages associated with a large number of user accounts.

As mentioned above, the client 102 can include client application 132 and client assistant 134. Client application 132 can provide a window to be displayed on a displaying device (e.g., a monitor) for rendering conversations associated with a particular user. The conversations and messages in the conversations can be encoded using HyperText Markup Language (HTML), XML, or any other appropriate markup language or encoding scheme, and then rendered by the client application 132. When a user submits a request through client application 132 to the information service 106 to access messages stored in the user's account, the information service 106 identifies conversations in the user's account in accordance with the user's request and transfers them as well as a set of display instructions back to the client 102. Client assistant 134 can, in response, generate one or more forms in accordance with the display instructions, where each form can include information of some of the conversations. The forms can then be submitted to and rendered by client application 132. In another embodiment, client assistant 134 may alternatively exist and operate in the information service 106.

The information service 106 and client assistant 134 work in concert to allow a user to view, compose, send and/or search messages in the user's message account and to present the search results in a highly intuitive fashion. The information service 106 extracts information from a user's message account by processing messages received, sent and/or being composed by the user, and the client assistant 134 assists in rendering the information prepared by the information service 106. In other embodiments a different division of duties between the information service 106 and the client assistant 134 can be implemented. Because many of the tasks performed by the system can be performed by either the information service 106 or the client assistant 134 or by the two working together, these two components are sometimes herein referred to jointly as the “conversation system”.

The conversation system can provide at least two different views, including a conversation list view and a conversation view as mentioned briefly above. In a conversation list view, a plurality of conversations can be displayed where each conversation can be displayed in a summary form. For example, each conversation can be represented by a number of conversation elements. The conversation elements can include one or more of: a number indicating the number of messages in the conversation, a list of one or more of the identifiers or names of the senders of messages in the conversation, a conversation description (e.g., a subject line of the message), a date/time value of the conversation (e.g., a date/time value of the last received message in the conversation), and a snippet from one or more of the messages in the conversation. In one approach, each conversation can be represented as a single row in the conversation list view.

In a conversation view, one or more messages from a conversation can be displayed. Each message can be displayed in one of a number of various modes, for example an expanded mode, a compacted mode, or a compressed mode. In an expanded mode, the body of the message can be displayed along with, for example, header information including names or other identifiers of the sender and the recipients of the message, a date/time value indicative of when the message is received or sent, routing information, and other properties of the message. An expanded mode can be used, for example, for messages which are marked as “unread.” In a compacted mode, the message body can be hidden and a snippet from the message is provided in its place. The snippet can be chosen to occupy less space than the body. For example, a snippet can be chosen to occupy only one line in a display window. The compacted mode can be used for messages which have been read or marked as read. The compacted mode allows messages in a conversation to be displayed within the same window more densely than if the expanded mode were used. In a compressed mode, a message can be represented with a small bar. The small bar can contain no message information. The visual effect of such a mode can be that multiple compressed messages appear like the edges of cards in a deck of cards. A user can toggle between the various display modes by selecting a message or using various controls in the display window. It should be understood that the techniques described in this specification with reference to a conversation (as might be found in the Google Gmail product) can be equally used with any message system (e.g., Outlook or Thunderbird) where messages can be displayed in various views (and can include portions of messages) such as a message view or a thread view where related messages can be displayed.

In some embodiments, when a conversation is being displayed in the conversation view, additional, content-targeted information (sometimes herein called “informational items”) can be displayed in the display window. For example, one or more advertisements relevant to, or related to, one or more of the messages in the conversation can be displayed. In another example, one or more other types of information can be displayed. Such other information can include, but is not limited to news items or links to news items, map links, phone numbers, links to product information, stock prices or links to stock prices, links to weather forecasts, web page links, dictionary entries or links to dictionary entries, images or links to images, RSS feeds or links to RSS feeds, links to blog (web log) events, links to user polls, links to files or other content on the client 102, and other types of information.

RSS feeds can be content distributed from various sources on a network (e.g., the Internet). RDF Site Summary (RSS) (and sometimes, Real Simple Syndication) is an XML-based lightweight multi-purpose extensible metadata description and syndication format. RSS is typically used for distributing various types of content to a number of receivers simultaneously. News items can be news items from one or more sources. Blog events can be events generated from one or more web logs (blogs). User polls can be polls that the user may participate in which may come from a variety of sources. Stock prices can be stock prices of companies whose names or stock ticker symbols are mentioned in the conversation. Weather forecasts can be weather forecasts of locations like cities or states whose names are directly or indirectly referred to by a message in the conversation.

Multiple factors affect the relevancy of an information item to a user of the information service. First, the relevancy of the information item to a user in many ways depends on the contents of the input associated with the user. Generally, when an advertising service returns advertisements based on text input, the more closely aligned the text input is with a concept or category that is also associated with the returned advertisements, the more relevant the returned advertisements are likely to be to the user. In some types of messages, certain terms or word phrases are frequently found, but may not be useful in obtaining relevant advertisements. For example, an electronic message from an on-line store notifying a customer that the product he or she ordered has been shipped might include, among other things, the product name and phrases such as “order has shipped”, “left the warehouse”, or “international air”. An advertising service receiving as input the entire message including both the product name and one or more of these boilerplate-type phrases might inadvertently return advertisements related to shipping, warehouses, or international shipping. These advertisements, although relevant to the phrases, are probably of little interest to the customer who is more interested in the product.

Second, the relevancy of the information item to a user may depend on whether the input associated with the user is indeed attributable to the user, and if so, to what extent. In a conversation among a group of friends about where to take vacation during a long weekend, a user may receive multiple messages from others proposing different sites A, B and C. Different advertisements related to the sites A, B, or C may be displayed alongside the messages depending upon what specific site(s) are mentioned in a particular message. However, when the user responds to the messages by recommending another vacation site D, it is more likely that he or she will be interested in information items related to site D, e.g., lodging, airfares and weather forecasts, but less interested in those related to the other sites proposed by somebody else. This inference is reasonable because the user suddenly changes from a “silent listener” to an active “speaker” in the conversation. A message composed and sent by the user certainly sheds more “light” on the user's thoughts and interests than messages in which the user is simply a recipient. Generally speaking, when pulling out content-targeted information from various sources, an information service can give different weights to contents of different messages depending on whether a message is authored by a user to whom the content-targeted information is to be served.

Time frame can be another important factor affecting the relevancy of an information item to a user, because the user's thoughts and interests may vary over time. For example, participants of a conversation often shift their interest from one subject to another. Therefore, different messages sent by the same participant at different times should be treated differently in terms of their respective alignments with the participant's current thoughts or interests. Returning to the vacation site example above, the user, after a few rounds of email exchanges, may send out a message including the title of a newly released movie in order to shift the conversation topic away from choosing a vacation site. Although the message body may still include multiple occurrences of the phrase “vacation site D”, an information item such as the movie's schedule at a nearby movie theater and a map link to driving directions to the movie theater may be more akin to the user's interest at the moment. In other words, an information service may need to allocate more weight to a more recently sent message than a less recently sent message in order to be better in synch with a user's current thoughts. This principle also applies to messages authored by other participants of a conversation.

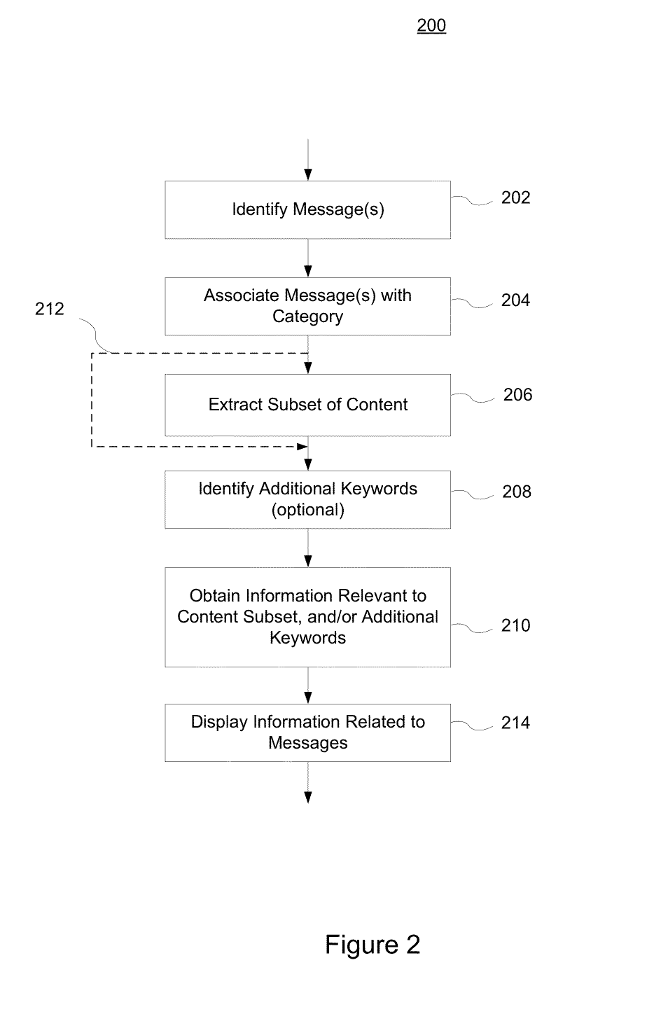

FIG. 2 illustrates a process by which content-targeted information can be generated in response to a message last sent by a user according to some embodiments of the invention. Initially, a conversation associated with the last sent message is identified (202). For example, the message may include an identifier of a conversation associated with the message. As mentioned above, a conversation can include one or more related messages. The identification at 202 can identify all of the messages in a conversation or selected messages in a conversation. Various selection criteria can be used when identifying selected messages in a conversation. For example, messages can be identified based on whether they were authored and sent by the user. Alternatively, messages can be identified based on whether a message was authored by the user within a predefined time period (e.g., the messages authored within the last 24 hours are identified). In another example, a conversation may be associated with a pool of messages of different types received or sent by the user, such as email messages, IM messages, transcribed voice messages, SMS messages and search queries. In this event, messages can be identified based on whether a message is of a particular type or types or a combination of two or more of the criteria mentioned above. For illustrative purposes, the following discussion assumes that the process of FIG. 2 is triggered by a user's act of sending a newly-composed message and is applied to one or more messages identified as being authored by the user within a predetermined time period. But one skilled in the art will appreciate that the process of FIG. 2 could be triggered by other types of events as well.

The identified messages can then be associated with one or more categories (204). Some examples of categories include, but are not limited to, online shopping, package shipping, travel, weather forecast, stock market, entertainment, dining, online auctions, health/beauty, taxes, real estate, computer software and hardware, and mortgages. More generally, the categories associated with the identified messages can include categories of things, activities, processes, events, concepts and the like. In some instances it is even possible that the messages may have no associated category. The operation of associating one or more categories with an identified message may be detection may be done before, in parallel with, or after sending the identified message as an outgoing message.

After determining that the messages are associated with one or more categories, a subset of the content of the messages can then be extracted (206). The content of the messages from which a subset can be extracted can include one or more of the following: a conversation description (e.g., a subject line of the message), one or more message bodies, a message sender domain, a message sender, a conversation label, one or more message labels, one or more message recipients, other message information, or information related to a conversation containing the messages. What is extracted from the messages into the subset can be dependent on the categories associated with the messages. The extracted subset can aid in obtaining the most relevant information from third party information servers by, for example, excluding from the subset content elements which may cause information not relevant to the pertinent portions of message to be returned from an information service (e.g., an advertisement service). Generally speaking, a content element is one or more terms, such as a word or phrase.

In some embodiments, one or more additional keywords can be identified (208) based on the associated categories and the content subset, and those additional keywords can be added to the content subset prior to the content subset being used to obtain relevant information. These additional keywords can increase a desired relevancy of the information returned from an information service. For example, a “stock market” category can be identified if the last sent message includes a public company's stock ticker symbol or company name. Furthermore, after the stock market category is identified, it can be useful to identify related keywords, such as “news” and “products”, which will be combined with the extracted content and sent to an information service. In other words, the additional keywords can be content elements that are related to a category, even if they are not present in the message or messages being processed.

The content elements in the content subset can be used to determine which additional keywords are added to the content subset. For example, finding an international flight number in a message sent by the user may cause the additional keywords “flight schedule” and “currency exchange,” and other related keywords as well, to be added to the content subset sent to the information service, whereas finding a domestic flight number in a message sent by a user would not cause the additional keyword “currency exchange” to be added to the content subset. As another example, if the destination of a flight can be determined (e.g., by identifying or decoding a city, airport or other location code), the name of the destination and the keyword “weather forecast” can be added to the content subset.

Information relevant to the extracted content is then obtained (210) from one or more information services (e.g., ad server 128 and/or information item server 130 providing services like stock quotes, maps, weather forecasts, etc.). The input provided to the information services can include one or more additional keywords identified at 208. In some embodiments (as represented by the dashed line at 212 in FIG. 2), additional keywords can be used in place of content extracted from the identified messages. In the information obtained from the information services may include content that is specifically relevant to the identified message(s), and may include web pages, links to web pages, content extracted from web pages, content extracted from one or more databases or other information sources, links for extracting such information from one or more databases or other information sources, and so on.

The information obtained from the information services can be prepared for display to a user who sends the last message that triggers the aforementioned process from a particular client 102. When the display is on the client 102, the information service 106 can provide formatting information directing the display of the information obtained from the information services.

Since this process is triggered by a user's act of sending a message, the obtained information is preferably displayed in a manner consistent with the user's expectation. For example, in one implementation, if the user sends the message to initiate a new conversation, he or she may not expect to see the message right away. Rather, the user will be directed to a conversation list view, in case there are one or more new messages awaiting attention from the user. But the user may prefer to see a highlighted confirmation message at a predetermined location in the conversation list view, e.g., “Your message has been sent.” at the top of the view. The confirmation may include a link back to the message. Accordingly, the obtained information can be displayed next to the confirmation message to attract the user's attention without disturbing the user's normal browsing activities. In some embodiments, the obtained information may include multiple items, but there is only limited space in the conversation list view for rendering them. In this event, the information service may choose to display in the available space just one or only a few information items deemed to be the most relevant to the user and include a link to other items. The user can click the link to view the other information items.

In another embodiment, the user may always be shown a view of the message he or she just sent. This may give the user a sense of closure, a chance to view the message with a fresh perspective, and the opportunity to make changes to the message such as adding labels and/or stars, replying to the message, or forwarding the message.

But if the user composes and sends the message from an existing conversation view, he or she may prefer to stay at the view to, e.g., check other unread messages in the same conversation. In some embodiments, the newly sent message is appended to the bottom of the existing conversation view with a highlighted confirmation message (e.g., “Your message has been sent”) on its top. Similarly, the aforementioned obtained information can be displayed next to the confirmation message, or above the view of messages in the conversation, to attract the user's attention without disturbing the user's normal browsing activities. In some embodiments, the information service may choose to display next to the confirmation message or above the view of messages just one or only a few information items deemed to be most relevant to the user. In addition, the information service may include a link to other obtained information items. The user can click the link to visit other information items. Alternatively, one or more of the items are listed vertically to the right of the just sent messages. These items may be the ones deemed less relevant than the information items displayed above the message. This arrangement of one or more obtained information items near or next to the just-sent message provides a hint to the user that these information items have a special tie with the just-sent message.

It will be understood by one skilled in the art that the aforementioned schemes of rendering the obtained information items in a display device are exemplary. There are many other rendering schemes that can be used. In most of these, the information items are displayed at a location of application or browser window that is prominent, but consistent with the normal experience that users have with a particular information service.

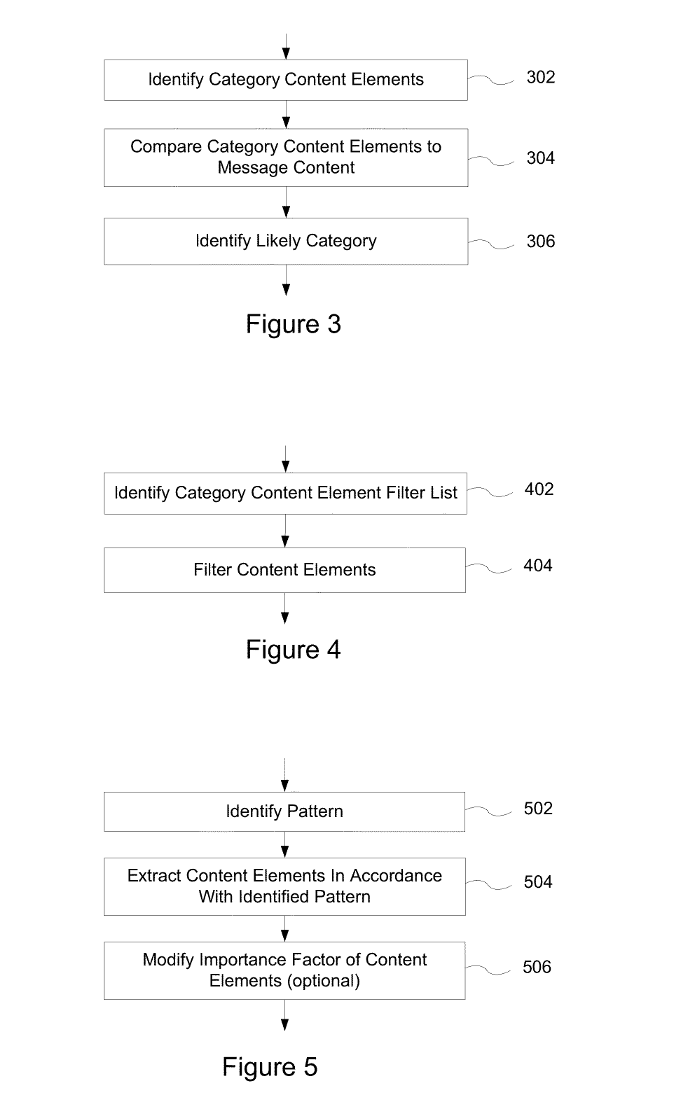

FIG. 3 illustrates an exemplary process for associating one or more identified messages with a category according to some embodiments. Initially, category content elements are identified in the messages (302). Category content elements can be organized into lists of content elements, where each list can be associated with a specific category. As mentioned earlier, each content element can comprise one or more terms. Broadly speaking, a category list for a category can comprise those content elements which are associated with that category. When the number of content elements associated with a particular category or the aggregated weight of the content elements associated with a particular category (assuming that different elements having different weights) has reached a predetermined threshold, then the messages are deemed relevant to that particular category. In another embodiment, when the percentage of identified content elements associated with a particular category within a message or set of messages reaches a predetermined threshold, and then the messages are deemed relevant to that particular category. A message can potentially include content elements associated with more than one category. Certain metrics can be used to distinguish a most relevant category from among categories that have some of their content elements present in a message. Returning to FIG. 3, the content of a message can be compared against a list of category content elements (304) and the most relevant category can be identified (306). The content of a message that is compared to the category lists can be one or more of the message subject, the message body, a message sender domain, a message sender name or identifier, a conversation label, one or more message labels, one or more message recipient names or identifiers, other message information, or information related to a conversation.

Category lists can be compared against the content of a message in a number of ways. For example, the number of times a particular content element from a category list appears in a message can be identified. In another example, each of the category lists and the message can be treated as a vector of terms and a comparison of a category list to the message can be measured by a vector distance. In some embodiments, the content of previous messages appearing in a last sent message (e.g., as might be found in a reply message) can be ignored in this category analysis. The most relevant category associated with a message can also be determined in a number of ways. For example, a category having the most number of unique content elements present in the message can be identified as the most relevant category. As another example, a category that has the highest ratio of the number of content elements which belong to that category as compared to the total number of identified content elements in the message can be identified as the most relevant category. If no content elements from any category content element list are present in the message, or if no metrics for any category are greater than a predetermined threshold (e.g., the number of unique content elements associated with a category list present in the message does not exceed a predetermined threshold), the message can be associated with no category.

FIG. 4 illustrates an exemplary process for extracting a subset of the content from one or more identified messages according to some embodiments. Initially, a category content element filter list can be identified (402). Each category (or each category in a subset of predefined categories) can have a filter list of content elements associated with it (i.e., a category content element filter list). Each filter list can comprise content elements which are associated with a particular category, but which, if included in the input provided to an information server (e.g., an ad server 128) may be likely to result in non-relevant information being returned. For example, a filter list for a category of “online shopping” can include the content element “receipt” and/or “your order has shipped”. Once the appropriate filter list has been identified, a content subset can be created by filtering those content elements in the list from the message (404). Other content elements can also be filtered which may not be directly related to a specific category, but nonetheless may be likely to result in an information service returning information not directly relevant to the conversation. For example, message header information and selected message component identifiers (e.g., “To:”) can be filtered from the identified messages, regardless of the identified category.

FIG. 5 illustrates another exemplary process for extracting a subset of the content from one or more identified messages according to some embodiments. The process of FIG. 5 can be used alone or in combination with the process of FIG. 4. A message can be examined to identify one or more patterns in the message (502). For example, a message that is being forwarded by the user may include automatically-generated package shipment notification. Alternately a user may copy and paste into a user-composed message an automatically-generated package shipment notification. The package shipment notification may include a package shipment tracking number that usually has a specific pattern comprising one or more alphanumeric characters and possibly some associated text. The associated text may include the domain name of the package shipping service provider and the name, model and price of the product in the package. But the user is probably more interested in the shipment status of the package itself, as identified by the tracking number, than other services provided by the shipping service provider or other similar products provided by other manufacturers or vendors from an information service point of view. In another example, a user-composed message may include (e.g., by using the “forward” feature of an email client) an earlier received message that contains reservation confirmation generated by an online dining reservation system. Alternately, the user may cut and paste this information into a user-composed message. The reservation confirmation can contain a pattern within which the most relevant information (e.g., the restaurant name) is embedded. In a reservation confirmation message the pattern can include, for example, the following text: “Your reservation is confirmed at”. Once the pattern has been identified, the content elements associated with the pattern can be filtered while the remaining content elements are extracted to the subset (504).

Optionally, an importance factor associated with one or more extracted content elements can be modified (506). An input to an information server (e.g., an ad server 128) can include information identifying the relative importance of one or more of the content elements in the input. Based on various selection criteria, it can be determined that one or more content elements provided in an input to an information server (e.g., an ad server 128) should be treated differently from other content elements. Accordingly, the output of the information server can be weighted toward those content elements deemed more important and/or down-weighted for those content elements deemed less important. One or more content elements associated with a particular part of a pattern can be accorded an importance factor(s) different from other parts of the extracted subset. For example, a content element associated with a product name can be accorded more weight than other extracted content elements, e.g., the color of the product.

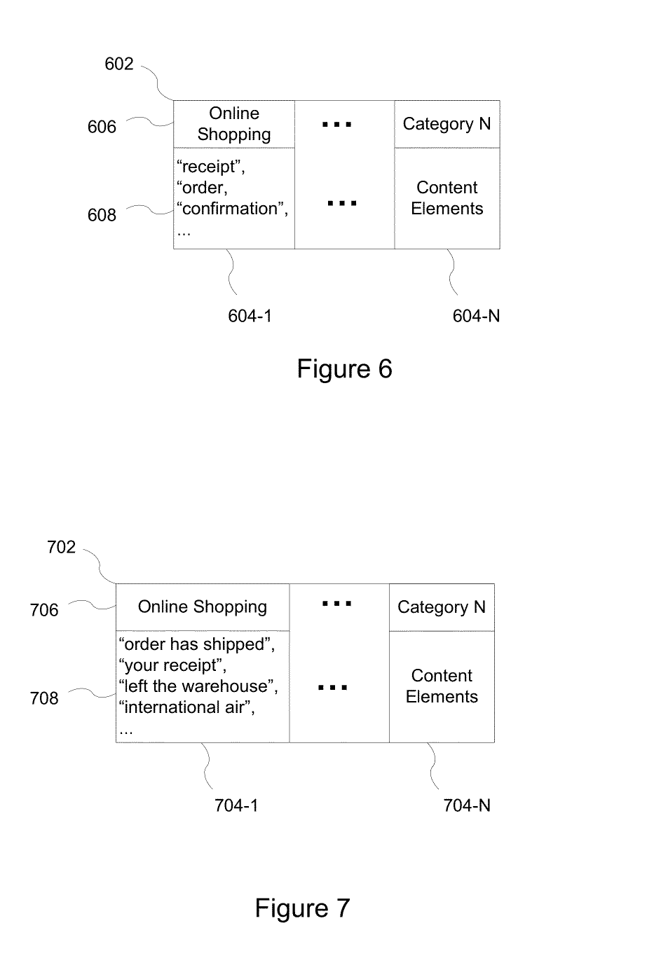

FIG. 6 illustrates an exemplary data structure for storing one or more category lists in accordance with some embodiments of the invention. Many other data structures, such as tree data structures, may be used to store category list information in other embodiments. A category list data structure 602 can include one or more category lists such as category list 604-1 to category list 604-N, where N is the number of predefined categories. Each category list can include a category identifier portion, such as category identifier portion 606, which identifies the category to which the category list is associated. Each category list can also include a content element list portion, such as content element list portion 608, which includes one or more content elements corresponding to the category with which the content element list is associated. In some embodiments, one or more of the content elements of a category can include a respective pattern for identifying content associated with the category. The content elements in each category list can be used to identify the category (or categories) associated with one or more identified messages. As discussed earlier, a message can be associated with one or more different categories. A content element can be present in multiple category lists.

FIG. 7 illustrates an exemplary data structure for storing one or more filter lists in accordance with some embodiments of the invention. Many other data structures, such as tree data structures, may be used to store filter list information in other embodiments. A filter list data structure 702 can include one or more filter lists such as filter list 704-1 to filter list 704-N, where N is the number of categories. Each filter list can include a category identifier, such as category identifier portion 706, which identifies the category to which the filter list is associated. Each filter list can include a filter list portion, such as filter list portion 708, which includes one or more content elements corresponding to the category with which the filter list is associated. The filter list portion 708 shown in FIG. 7 provides some exemplary content elements (e.g., “order has shipped”) associated with an online shopping category. The content elements in each filter list can be used to filter out content elements which might otherwise result in an information server returning non-relevant information.

FIGS. 6 and 7 each illustrate one of many possible data structures for storing category lists and category filter lists. One of ordinary skill in the art will recognize other ways that the information can be organized to achieve the same result.

Note that the system 100 shown in FIG. 1 and the process shown in FIGS. 2-5 are also applicable when relevant information is sought for one or more conversations, each having one or more messages authored by a particular user. The present invention increases the likelihood of identifying and displaying one or more information items relevant to a user who authored the most recent message in a conversation by giving more weight to the content provided by the user in that last message than content provided by other messages, by other authors, in the conversation. As mentioned earlier, messages recently authored by the user are favored over other messages in the same conversation because the contents of these messages are more likely to reflect the user's current thoughts and interests than other messages that are older and/or authored by others. This approach can be implemented as suggested above by limiting the input to an information server to a set of identified messages within a conversation and therefore reducing the processing overhead for the information server. An alternative approach is to provide all messages within a conversation to the information server and then re-ordering the information output from the information server using one or more messages sent by the user (e.g., the message last sent by the user that triggers the process). Although this approach may increase the computational cost, it nonetheless broadens the potential sources of relevant information and may recover some information items that might be completely missed by the other approach.

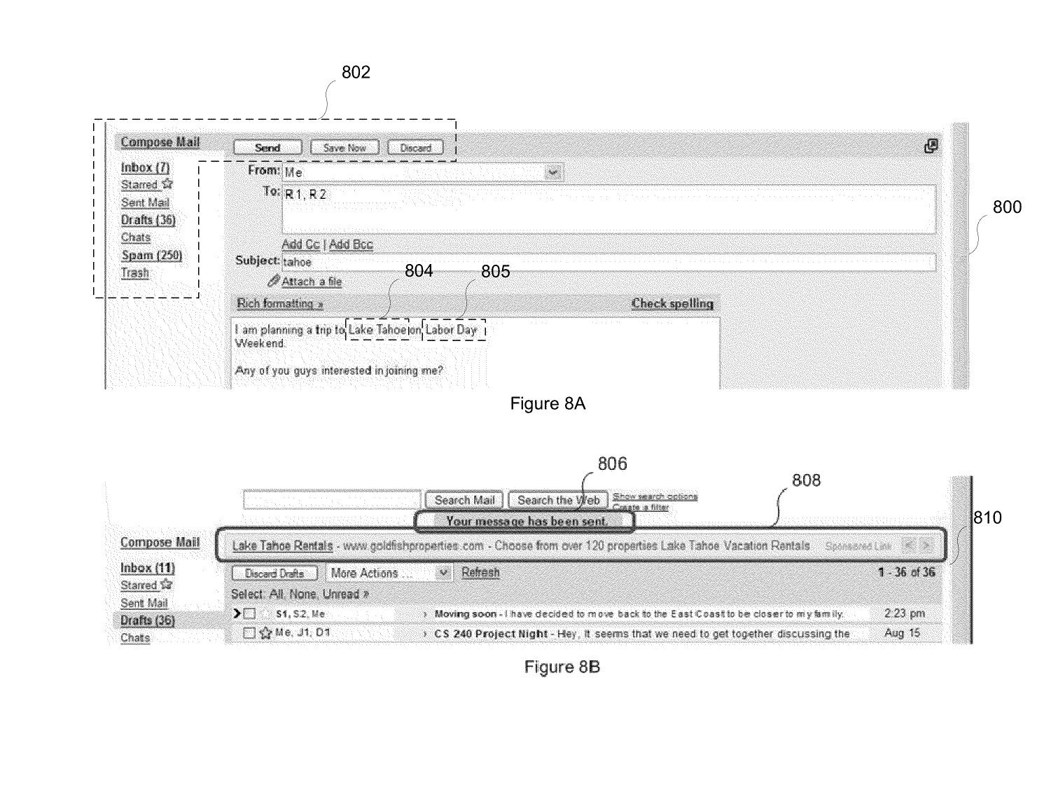

FIGS. 8A and 8B illustrate two exemplary screenshots of a message composition and the display of content-targeted information in accordance with some embodiments of the presentation. The message composition screenshot 800 includes a navigation and control portion 802. The navigation and control portion 802 can include one or more navigation and/or control items (e.g., a “Compose mail” link and “Send” button). Since the message being composed here is the first one that starts a new conversation, the screenshot does not show any other messages. A user writes this message to his or her friends, asking them if they are interested in visiting Lake Tahoe during the Labor Day weekend. After completion of the message, the user clicks the “Send” button to send the message from a client 102 to an information service 106.

Upon receipt of the message, the information service 106 durably stores the message (e.g., in a storage server) and sends message to its recipients “R1” and “R2”. Additionally, the information service 106 can infer that the message may be associated with a predefined travel category from the content of the message, since the message portion 804 “Lake Tahoe” is a well known tourist site. The message portion 805 “Labor Day” is probably related to categories like travel, shopping and holiday. So the combination of the two key terms in the message body suggests that the user may be interested in information related to Lake Tahoe during the Labor Day holiday, such as car rental, lodging, map, weather forecast, and dining information. Accordingly, the information server may prepare and submit one or more requests to various information item servers. One of the requests may be sent to a weather forecast server soliciting weather information at Lake Tahoe during the Labor Day weekend. One of the requests may be sent to a map server requesting driving directions to Lake Tahoe. One of the requests may be sent to an ad server seeking advertisements most relevant to a Lake Tahoe visitor (e.g., rental car service, vacation house rental, etc.). Alternately, the aforementioned requests may be a request for a link to a website or webpage that provides weather information at Lake Tahoe; a request for a link to a map server, where the link identifies the map and/or driving instructions to be obtained from the map server; and a request for one or more links to advertisements relevant to a Lake Tahoe visitor. After collecting items from various information item servers, the information service 106 prepares a response including one or more information items ordered by estimated relevance to the user, with the more relevant ones positioned ahead of less relevant ones, and returns the response to the requesting client 102.

FIG. 8B is a screenshot illustrating how the response is rendered at the client 102. As mentioned earlier, in this example the information service returns the user's email window to the conversation list view 810 since the last sent message is the first one in the conversation. The last sent message can be found in the “Sent Mail” conversation list view if the user has chosen this option. In this example, while the user composes the last sent message, four new messages arrive at the user's mailbox and the number of new messages in the “Inbox” folder grows from 7 to 11 (as can be seen by comparing FIGS. 8A and 8B). On top of the conversation list view 810, there is a highlighted confirmation message 806 notifying the user that the last message has been sent. An advertisement is displayed in an information region 808 right below the confirmation message 806. Illustratively, the information service 106 concludes that this advertisement is probably relevant to the user's current thoughts or interests based on the content of the last sent message. If the user is interested in other information items, he or she can click the arrow button “>” at the right end of the information region 808. Clicking on the arrow button causes a subsequent information item to be displayed in the information region 808 in place of the previously displayed information region. Alternatively, a new window may pop up on the client 102 providing other relevant information, e.g., if the user clicks the “Sponsored Link” link in region 808. Alternatively, the information region 808 may expand to reveal more information items. In doing so, the information region 808 may displace or cover at least a portion of other content on the display.

If the last sent message is a response to another message within an existing conversation, the user may return to a new conversation view that includes the last sent message. In some embodiments, the last sent message is appended to the end of a list of messages in the conversation or a message conversation list. The list of messages in the conversation may include both messages authored by the user and messages authored by other participants of the conversation. In some other embodiments, the last sent message is inserted into the list, e.g., immediately following the message to which the user just responded. In this case, the most relevant information 808 returned by the information service can be displayed next to the confirmation message 806, above a list of messages in the conversation, or another predetermined location in the display, e.g., to the right of the last sent message.

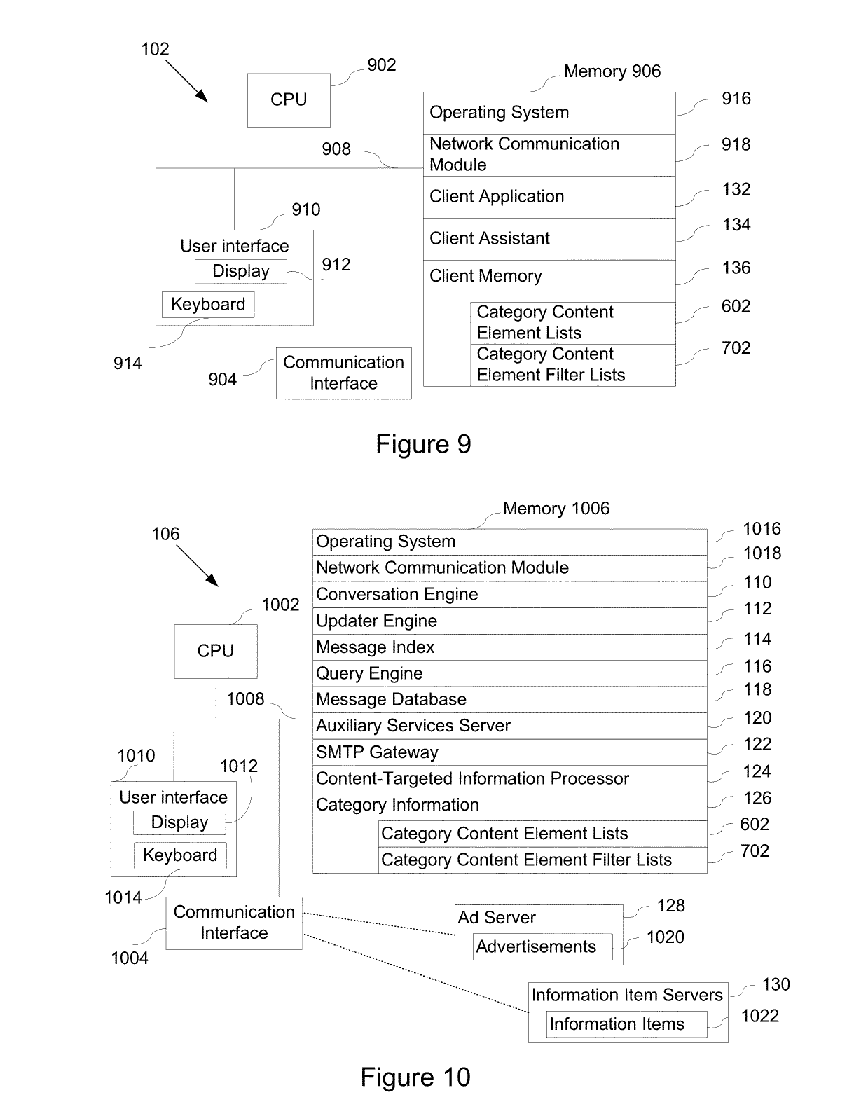

FIG. 9 is a block diagram illustrating a client 102 in accordance with one embodiment of the present invention. The client 102 typically includes one or more processing units (CPUs) 902, one or more network or other communications interfaces 904, a memory 906, and one or more communication buses 908 for interconnecting these components. The client 102 optionally may include a user interface 910 comprising a display device 912 and a keyboard 914. The memory 906 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 906 may optionally include one or more storage devices remotely located from the CPU(s) 902. In some embodiments, the memory 906 stores the following programs, modules and data structures, or a subset thereof:
an operating system 916 that includes procedures for handling various basic system services and for performing hardware dependent tasks;
a network communication module 918 that is used for connecting the client 102 to other computers via the one or more communication network interfaces 904 and one or more communication networks, such as the Internet, other wide area networks, local area networks, metropolitan area networks, and so on;
a client application 132 that can permit a user to interact with the client 102 as described above;
a client assistant 134 that can perform one or more tasks as described above; and
a client memory 136 that can optionally include category list data structure 602 and filter list structure 702, examples of which are described above.

FIG. 10 is a block diagram illustrating an information service 106 in accordance with one embodiment of the present invention. The information service 106 typically includes one or more processing units (CPUs) 1002, one or more network or other communications interfaces 1004, a memory 1006, and one or more communication buses 1008 for interconnecting these components. The information service 106 optionally may include a user interface 1010 comprising a display device 1012 and a keyboard 1014. The memory 1006 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 1006 may optionally include one or more storage devices remotely located from the CPU(s) 1002. In some embodiments, the memory 1006 stores the following programs, modules and data structures, or a subset thereof:
an operating system 1016 that includes procedures for handling various basic system services and for performing hardware dependent tasks;
a network communication module 1018 that is used for connecting the information service 106 to other computers via the one or more communication network interfaces 1004 and one or more communication networks, such as the Internet, other wide area networks, local area networks, metropolitan area networks, and so on;
a content-targeted information processor 124 for obtaining content-targeted information for one or more identified messages as described above; and
category information 126 that can include category list data structure 602 and filter list structure 702, examples of which are described above.

In some embodiments, the information service 106 includes the following elements, or a subset or superset of such elements: a conversation engine 110 for responding to a variety of requests from the client assistant 134 returning conversation-based responses; an updater engine 112 for updating a message database 118; a message index 114 containing index information for messages in the message database 118; a query engine 116 for performing various queries using the message index 114 and message database 118; an auxiliary services server 120 for performing various auxiliary services; and an SMTP gateway 122 for sending and receiving messages.

The information service 106 can be connected to ad server 128 and/or information item server 130 via the communication interface 1004. Ad server 128 can contain one or more advertisements 1020. The ad server 128 can receive input and return advertisements that can be relevant to the input. The information item server 130 can include one or more information items 1022. Similar to the ad server 128, the information server 130 can receive input and return informational items that can be relevant to the input.

Each of the above identified elements in FIGS. 9 and 10 may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, the memory 906 may store a subset of the modules and data structures identified above. Furthermore, the memory 906 may store additional modules and data structures not described above.

Although FIGS. 9 and 10 show respectively a client 102 and an information service 106, the figures are intended more as functional descriptions of the various features which may be present in a client and set of servers than as a structural schematic of the embodiments described herein. In practice, and as recognized by those of ordinary skill in the art, items shown separately could be combined and some items could be separated. For example, some items shown separately in FIG. 10 could be implemented on single servers and single items could be implemented by one or more servers. The actual number of servers used to implement an information service 106 and how features are allocated among them will vary from one implementation to another, and may depend in part on the amount of data traffic that the system must handle during peak usage periods as well as during average usage periods.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A computer-implemented method of serving information items in association with a message sent by a client, comprising:
on a server having one or more processors and memory for storing one or more programs:
identifying a message sent by the client;
extracting content elements from the message, the extracted content elements comprising two or more content elements of the message;
identifying one or more categories corresponding to the message;
after extracting the content elements from the message and identifying the one or more categories, selecting, in accordance with the one or more categories corresponding to the message, a subset of the extracted content elements, the subset comprising one or more content elements of the message, while excluding from the selected subset other ones of the extracted content elements in accordance with the one or more categories corresponding to the message;
obtaining at least one information item associated with the selected subset of the extracted content elements; and
after obtaining the at least one information item, transmitting to the client the at least one information item, wherein the at least one information item is for display at the client after the at least one identified message has been sent by the client.

2. The method of claim 1, wherein said excluding includes excluding from the selected subset of the extracted content elements, extracted content elements matching items in a filter list for any of the one or more categories.

3. The method of claim 1, further comprising:
preparing for concurrent display, at the client, the at least one information item, a confirmation message that the identified message has been sent, and a conversation list that includes information about messages other than the identified message.

4. The method of claim 1, further comprising:
preparing for concurrent display at the client the at least one information item, a confirmation message that the identified message has been sent, and a conversation list that includes information about a plurality of conversations, including at least one conversation having a plurality of messages.

5. The method of claim 1, further comprising:
preparing for concurrent display at the client the at least one information item, and a conversation list that includes information about a plurality of conversations, including at least one conversation having a plurality of messages.

6. A computer-implemented method of serving information items in association with a message sent by a client, comprising:
on a server having one or more processors and memory for storing one or more programs:
identifying a message sent by the client and a corresponding conversation that includes a plurality of messages;
extracting content elements from the plurality of messages, the extracted content elements comprising two or more content elements from the plurality of messages in the identified conversation;
identifying one or more categories corresponding to the plurality of messages in the identified conversation;
after extracting the content elements from the plurality of messages and identifying the one or more categories, selecting, in accordance with the one or more categories corresponding to the plurality of messages in the identified conversation, a subset of the extracted content elements, the subset comprising one or more content elements of the identified conversation, while excluding from the selected subset other ones of the extracted content elements in accordance with the one or more categories corresponding to the plurality of messages in the identified conversation;
obtaining at least one information item associated with the selected subset of the extracted content elements; and
after obtaining the at least one information item, transmitting to the client the at least one information item and conversation information about the plurality of messages in the identified conversation, wherein the at least one information item is for display at the client after the identified message has been sent by the client.

7. The method of claim 6, wherein said excluding includes excluding from the selected subset of the extracted content elements, extracted content elements matching items in a filter list for any of the one or more categories.

8. The method of claim 6, further comprising:
preparing for concurrent display at the client the at least one information item, a confirmation message that the identified message has been sent, and a conversation list that includes information about messages other than the identified message.

9. The method of claim 6, further comprising:
preparing for concurrent display at the client the at least one information item, and a conversation list that includes information about a plurality of conversations, including at least one conversation having a plurality of messages.

10. A server system for serving information items in association with a message sent by a client, comprising:
memory;
one or more processors; and
at least one program, stored in the memory and executed by the processor, the at least one program including instructions that are executed by the one or more processors so as to cause the server system to:
identify a message sent by the client;
extract content elements from the message, the extracted content elements comprising two or more content elements of the message;
identify one or more categories corresponding to the message;
after extracting the content elements from the message and identifying the one or more categories, select, in accordance with the one or more categories corresponding to the message, a subset of the extracted content elements, the subset comprising one or more content elements of the message, while excluding from the selected subset other ones of the extracted content elements in accordance with the one or more categories corresponding to the message;
obtain at least one information item associated with the selected subset of the extracted content elements; and
after obtaining the at least one information item, transmit to the client the at least one information item, wherein the at least one information item is for display at the client after the at least one identified message has been sent by the client.

11. The system of claim 10, wherein said excluding includes excluding from the selected subset of the extracted content elements, extracted content elements matching items in a filter list for any of the one or more categories.

12. The system of claim 10, wherein the at least one program includes instructions to:
prepare for concurrent display at the client the at least one information item, a confirmation message that the identified message has been sent, and a conversation list that includes information about messages other than the identified message.

13. The system of claim 10, wherein the at least one program includes instructions to:
prepare for concurrent display at the client the at least one information item, a confirmation message that the identified message has been sent, and a conversation list that includes information about a plurality of conversations, including at least one conversation having a plurality of messages.

14. The system of claim 10, wherein the at least one program includes instructions to:
prepare for concurrent display at the client the at least one information item, and a conversation list that includes information about a plurality of conversations, including at least one conversation having a plurality of messages.

15. A server system for serving information items in association with a message sent by a client, comprising:
memory;
one or more processors; and
at least one program, stored in the memory and executed by the processor, the at least one program including instructions that are executed by the one or more processors so as to cause the server system to:
identify a message sent by the client and a corresponding conversation that includes a plurality of messages;
extract content elements from the plurality of messages, the extracted content elements comprising two or more content elements from the plurality of messages in the identified conversation;
identify one or more categories corresponding to the plurality of messages in the identified conversation;
after extracting the content elements from the plurality of messages and identifying the one or more categories, select, in accordance with the one or more categories corresponding to the plurality of messages in the identified conversation, a subset of the extracted content elements, the subset comprising one or more content elements of the identified conversation, while excluding from the selected subset other ones of the extracted content elements in accordance with the one or more categories corresponding to the plurality of messages in the identified conversation;
obtain at least one information item associated with the selected subset of the extracted content elements; and
after obtaining the at least one information item, transmit to the client the at least one information item and conversation information about the plurality of messages in the identified conversation, wherein the at least one information item is for display at the client after the identified message has been sent by the client.

16. The system of claim 15, wherein said excluding includes excluding from the selected subset of the extracted content elements, extracted content elements matching items in a filter list for any of the one or more categories.

17. The system of claim 15, wherein the at least one program includes instructions to:
prepare for concurrent display at the client the at least one information item, a confirmation message that the identified message has been sent, and a conversation list that includes information about messages other than the identified message.

18. The system of claim 15, wherein the at least one program includes instructions to:
prepare for concurrent display at the client the at least one information item, and a conversation list that includes information about a plurality of conversations, including at least one conversation having a plurality of messages.

19. A non-transitory computer readable storage medium storing one or more programs executed by one or more processors of a server system so as to cause the server system to:
identify a message sent by the client;
extract content elements from the message, the extracted content elements comprising two or more content elements of the message;
identify one or more categories corresponding to the message;
after extracting the content elements from the message and identifying the one or more categories, select, in accordance with the one or more categories corresponding to the message, a subset of the extracted content elements, the subset comprising one or more content elements of the message, while excluding from the selected subset other ones of the extracted content elements in accordance with the one or more categories corresponding to the message;
obtain at least one information item associated with the selected subset of the extracted content elements; and
after obtaining the at least one information item, transmit to the client the at least one information item, wherein the at least one information item is for display at the client after the at least one identified message has been sent by the client.

20. The non-transitory computer readable storage medium of claim 19, wherein said excluding includes excluding from the selected subset of the extracted content elements, extracted content elements matching items in a filter list for any of the one or more categories.

21. The non-transitory computer readable storage medium of claim 19, wherein the one or more programs further cause the server system to:
prepare for concurrent display at the client the at least one information item, a confirmation message that the identified message has been sent, and a conversation list that includes information about messages other than the identified message.

22. The non-transitory computer readable storage medium of claim 19, wherein the one or more programs further cause the server system to:
prepare for concurrent display at the client the at least one information item, a confirmation message that the identified message has been sent, and a conversation list that includes information about a plurality of conversations, including at least one conversation having a plurality of messages.

23. The non-transitory computer readable storage medium of claim 19, wherein the one or more programs further cause the server system to:
prepare for concurrent display at the client the at least one information item, and a conversation list that includes information about a plurality of conversations, including at least one conversation having a plurality of messages.

24. A non-transitory computer readable storage medium storing one or more programs executed by one or more processors of a server system so as to cause the server system to:
identify a message sent by the client and a corresponding conversation that includes a plurality of messages;
extract content elements from the plurality of messages, the extracted content elements comprising two or more content elements from the plurality of messages in the identified conversation;
identify one or more categories corresponding to the plurality of messages in the identified conversation;
after extracting the content elements from the plurality of messages and identifying the one or more categories, select, in accordance with the one or more categories corresponding to the plurality of messages in the identified conversation, a subset of the extracted content elements, the subset comprising one or more content elements of the identified conversation, while excluding from the selected subset other ones of the extracted content elements in accordance with the one or more categories corresponding to the plurality of messages in the identified conversation;
obtain at least one information item associated with the selected subset of the extracted content elements; and
after obtaining the at least one information item, transmit to the client the at least one information item and conversation information about the plurality of messages in the identified conversation, wherein the at least one information item is for display at the client after the identified message has been sent by the client.

25. The non-transitory computer readable storage medium of claim 24, wherein said excluding includes excluding from the selected subset of the extracted content elements, extracted content elements matching items in a filter list for any of the one or more categories.

26. The non-transitory computer readable storage medium of claim 24, wherein the one or more programs further cause the server system to:
prepare for concurrent display at the client the at least one information item, a confirmation message that the identified message has been sent, and a conversation list that includes information about messages other than the identified message.

27. The non-transitory computer readable storage medium of claim 24, wherein the one or more programs further cause the server system to:
prepare for concurrent display at the client the at least one information item, and a conversation list that includes information about a plurality of conversations, including at least one conversation having a plurality of messages.

28. The method of claim 1, wherein said excluding includes excluding from the selected subset of the extracted content elements one or more extracted content elements that are not related to the one or more categories corresponding to the message.

29. The method of claim 1, further comprising:
transmitting, to the client, a web page that includes embedded instructions to concurrently display the at least one information item and a conversation list of two or more conversations.

30. The method of claim 6, wherein said excluding includes excluding from the selected subset of the extracted content elements one or more extracted content elements that are not related to the one or more categories corresponding to the plurality of messages in the identified conversation.

31. The method of claim 6, further comprising:
transmitting, to the client, a web page that includes embedded instructions to concurrently display the at least one information item and a conversation list of two or more conversations, the conversation list includes the identified conversation.
